(19) United States
(12) Patent Application Publication
(10) Pub. No.: US 2012/0331162 A1
(43) Pub. Date: Dec. 27, 2012

(54) METHOD FOR SHARING CONTENTS USING TEMPORARY KEYS AND ELECTRONIC DEVICE USING THE SAME

(75) Inventors: Jae-yoon JUNG, Suwon-si (KR); Jung-yon CHO, Seongnam-si (KR); Jin-woo HONG, Suwon-si (KR); Si-hong PARK, Seoul (KR)

(73) Assignee: SAMSUNG ELECTRONICS CO., LTD., Suwon-si (KR)

(21) Appl. No.: 13/431,525

(22) Filed: Mar. 27, 2012

(30) Foreign Application Priority Data
Jun. 27, 2011 (KR) 10-2011-0062510

(51) Int. Cl. G06F 15/16

(52) U.S. Cl. 709/229

(57) ABSTRACT

An electronic device, a method for sharing content using temporary keys and a display apparatus using the same are provided. The method includes displaying a graphical user interface (GUI) for registering a temporary key; if a temporary key is input via the GUI, transmitting the inputted temporary key to a server; registering the input temporary key with the server; establishing a network connection with the server and at least one other electronic device, if the at least one other electronic device is authenticated by the server via the registered temporary key; and performing one of transmitting the content to the at least one other electronic device and receiving the content from the at least one other electronic device.

### CROSS-REFERENCE TO RELATED APPLICATION

This application claims priority under 35 U.S.C. §119 from Korean Patent Application No. 10-2011-0062510, filed on Jun. 27, 2011, in the Korean Intellectual Property Office, the disclosure of which is incorporated herein by reference in its entirety.

### BACKGROUND

1. Field

Devices and methods consistent with the present exemplary embodiments relate to sharing content, and more particularly, to sharing content by establishing a network connection using a temporary key.

2. Description of the Related Art

Recently, as networking functions are added to many electronic devices, a home networking system is developing which includes many electronic device. That is, with a network system, a user is able to control other electronic devices using a single electronic device or transmit and/or receive content to and from the other electronic devices. However, a communication using such a home network system is possible only within a limited area, generally only inside of a home.

However, users want to access content stored in a device at home while they are outside where an Internet connection is available, and further want to share content with other electronic devices outside of the home.

Therefore, there is a need for methods that allow users to share content stored in electronic devices at home with other devices from outside more conveniently.

### SUMMARY

Exemplary embodiments address at least the above problems and/or disadvantages and other disadvantages not described above. However, an exemplary embodiments is not required to overcome the disadvantages described above, and an exemplary embodiment may not overcome any of the problems described above.

According an aspect of an exemplary embodiment, there is provided a method for sharing content of an electric device, the method including: displaying a graphical user interface (GUI) for registering a temporary key; if a temporary key is input via the GUI, transmitting the input temporary key to a server; registering the temporary key with the server; establishing a network connection with the server and at least one other electronic device, if the at least one other electronic device is authenticated by the server via the registered temporary key; and performing one of transmitting the content to the at least one other electronic device and receiving the content from the at least one other electronic device.

The GUI may include an item for setting at least one of an identification of the temporary key, a password of the temporary key and an expiration date of the temporary key.

The registering may include transmitting information of the electronic device along with the temporary key to the server and registering the information of the electronic device along with the temporary key with the server.

The establishing of the network connection may further include: generating another GUI including information that the network connection is established with the at least one other electronic device.

The method may further include: displaying a list including the at least one other electronic device.

The method may further include: if a command is input by a user, generating another GUI for releasing the temporary key; and releasing the temporary key.

The releasing of the temporary key may include inputting the registered temporary key to the other GUI.

The performing the one of the transmitting the content to the at least one other electronic device and the receiving the content from the at least one other electronic device may include performing the one of the transmitting the content to the at least one other electronic device and receiving the content from the at least one other electronic device either via the server or directly.

The temporary key may include at least one of a disposable identification and a disposable password.

The displaying may include displaying the GUI if a button is pressed by a user.

According an aspect of another exemplary embodiment, there is provided an electronic device which communicates with a server and at least one other electronic device via a network connection, the electronic device including: a GUI generating unit configured to generate a GUI for inputting a temporary key; a display unit configured to display the generated GUI; a communication unit configured to transmit the temporary key input via the GUI to the server; and a control unit configured to control the communication unit to perform one of transmitting the content to the at least one other electronic device and receiving the content from the at least one other electronic device, if the network connection is established with the at least one other electronic device and the at least one other electronic device is authenticated by the server via the temporary key.

The GUI may include an item for setting at least one of an identification of the temporary key, a password of the temporary key and an expiration date of the temporary key.

The control unit may further be configured to control the communication unit to transmit information of the electronic device and the temporary key to the server, if the temporary key is registered with the server.

The control unit may control the GUI generating unit to generate another GUI including information that the network connection is established with the at least one other electronic device, if the network connection is established.

The control unit may further be configured to control the GUI generating unit to generate a list including the at least one other electronic device and to control the display unit to display the generated list.

The control unit may further be configured to control the GUI generating unit to generate another GUI for releasing the temporary key, if a command is input by a user.

The control unit may further be configured to release the temporary key if the registered temporary key is input to the other GUI.

The communication unit may perform one of transmitting the content to the at least one other electronic device and receiving the content from the at least one other electronic device.

The temporary key may include at least one of a disposable identification and a disposable password.

The control unit may further be configured to control the GUI generating unit to generate the GUI if a button is pressed by a user.

According an aspect of another exemplary embodiment, there is provided an electronic device which communicates with at least one other electronic device via a network connection, the electronic device including: a GUI generating unit configured to generate a GUI for inputting a temporary key; a display unit configured to display the generated GUI; a communication unit configured to communicate with at least one of a sever and the at least one other electronic device; and a control unit configured to control the communication unit to transmit the temporary key to the server if the temporary key is input via the GUI, and to control the communication unit to receive information from the server, wherein if the information received from the server includes authentication information indicating the at least one other electronic device is authenticated by the server via the temporary key, the control unit is further configured to control the communication unit to establish the network connection with the at least one other electronic device and to transmit the content to the at least one other electronic device via the network connection.

According an aspect of another exemplary embodiment, there is provided an electronic device which communicates with at least one other electronic device via a network connection, the electronic device including: a GUI generating unit configured to generate a GUI for inputting a temporary key; a display unit configured to display the generated GUI; a communication unit configured to communicate with at least one of a sever and the at least one other electronic device; and a control unit configured to control the communication unit to transmit the temporary key to the server if the temporary key is input via the GUI, and to control the communication unit to receive information from the server, wherein if the information received from the server includes authentication information indicating the at least one other electronic device is authenticated by the server via the temporary key, the control unit is further configured to control the communication unit to establish the network connection with the at least one other electronic device and to receive the content from the at least one other electronic device via the network connection.

According an aspect of another exemplary embodiment, there is provided an electronic device which communicates with at least one other electronic device via a network connection, the electronic device including: a GUI generating unit configured to generate a GUI for inputting a temporary key; a display unit configured to display the generated GUI; a communication unit configured to communicate with at least one of a sever and the at least one other electronic device; and a control unit configured to control the communication unit to transmit the temporary key to the server if the temporary key is input via the GUI, and configured to determine whether the at least one other electronic device is authenticated by the server via the temporary key, wherein if the at least one other electronic device is authenticated by the server via the temporary key, the control unit is further configured to control the communication unit to establish the network connection with the at least one other electronic device and to transmit the content to the at least one other electronic device via the network connection.

The temporary key may include a one-time password.

The GUI generating unit may further be configured to generate another GUI for releasing the temporary key.

The GUI generating unit may further be configured to generate a GUI item for setting at least one of an identification of the temporary key, a password of the temporary key and an expiration date of the temporary key.

### BRIEF DESCRIPTION OF THE DRAWINGS

The above and/or other aspects of the will be more apparent by describing certain exemplary embodiments with reference to the accompanying drawings, in which:

FIG. 1 is a view illustrating a content sharing system according to an exemplary embodiment;

FIG. 2 is a block diagram illustrating an electronic device according to an exemplary embodiment;

FIG. 3 is a view illustrating a GUI for registering a temporary key according to an exemplary embodiment;

FIG. 4 is a view illustrating a GUI for another electronic device to be authenticated by a server according to an exemplary embodiment;

FIG. 5 is a view of a GUI containing information that a network connection is established with the other electronic device according to an exemplary embodiment;

FIG. 6 is a view illustrating a list of other electronic devices with which a network connection has been established according to an exemplary embodiment;

FIG. 7 is a view illustrating a GUI for releasing a temporary key according to an exemplary embodiment;

FIG. 8 is a flowchart provided to explain a method for sharing content of an electronic device according to an exemplary embodiment;

FIG. 9 is a flowchart provided to explain a method for sharing content of a content sharing system according to an exemplary embodiment;

### DETAILED DESCRIPTION OF EXEMPLARY EMBODIMENTS

Certain exemplary embodiments will now be described in greater detail with reference to the accompanying drawings.

In the following description, the same drawing reference numerals are used for the same elements even in different drawings. The matters defined in the description, such as detailed construction and elements, are provided to assist in a comprehensive understanding. Also, well-known functions or constructions are not described in detail since they would obscure explanation with unnecessary detail. The terms “unit” and “block” as used herein mean a hardware component, such as a processor or circuit, and/or a software component that is executed by a hardware component such as a processor.

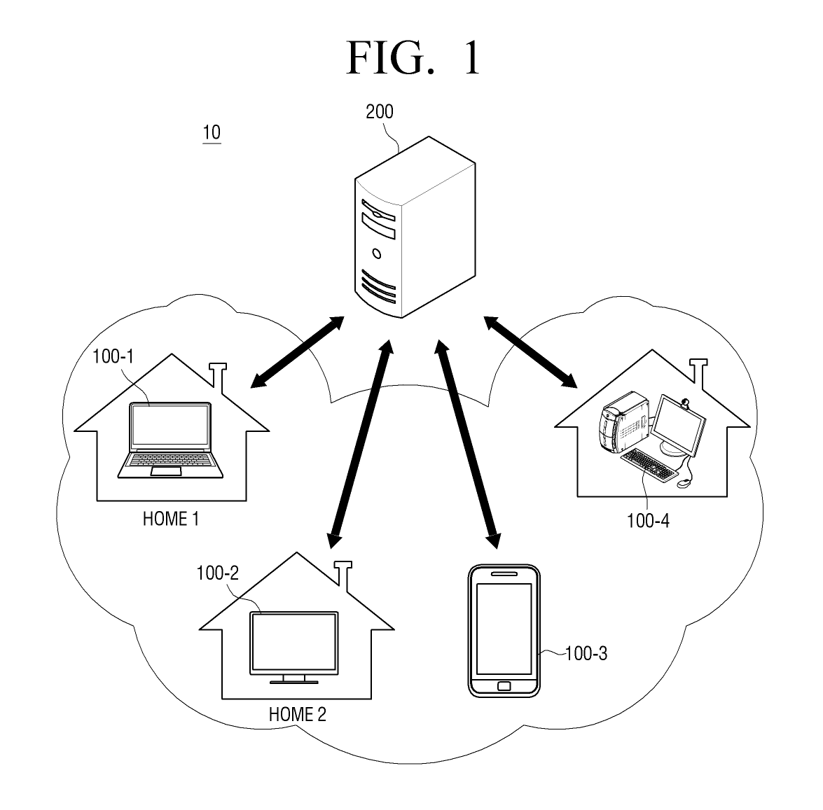

FIG. 1 is a view illustrating a content sharing system 10 according to an exemplary embodiment. As illustrated in FIG. 1, the content sharing system 10 includes a plurality of other electronic devices 100-1, 100-2, 100-3, 100-4 and a server 200.

One of the plurality of electronic devices 100-1 (hereinafter, referred to as ‘electronic device’) registers a temporary key with a server, other electronic devices 100-2, 100-3, 100-4 (hereinafter, referred to as ‘other electronic devices’), excluding the electronic device 100-1, are authenticated by the server 200, using the temporary key registered with the server 200. When the other electronic devices 100-2, 100-3, 100-4 are authenticated by the server, the plurality of other electronic devices 100-1, 100-2, 100-3, 100-4 form a cloud network and transmit and/or receive content.

Herein, the temporary key is a One-Time Password (OTP), which is different from general identifications (IDs) or passwords, to authenticate temporarily the other electronic device 100-2 and thus, may be released and may be setup by a user to have an expiration date.

In this case, the plurality of electronic devices 100-1,100-2,100-3,100-4 may be embodied as one of a notebook, a TV, a smart phone a computer, etc., which contain a communication function to access the server 200 as illustrated in FIG. 1. But this is only an example. The technical features of the present exemplary embodiments may be applied to any other electronic device which is able to access the server 200.

If the electronic device 100-1 requests registration of a temporary key, the server 200 receives the information of the temporary key and the electronic device 100-1 from the electronic device 100-1. And if the other electronic devices 100-2, 100-3, 100-4 respectively request authentication from the server 200 using the temporary key, the server 200 authenticates the other electronic devices 100-2, 100-3, 100-4 and transmits the information of the other electronic devices 100-2, 100-3, 100-4 requesting for forming a cloud network and the information of the other electronic devices 100-2, 100-3, 100-4 to the electronic device 100-1.

Accordingly, the electronic device 100-1 and the other electronic devices 100-2, 100-3, 100-4 form a cloud network, and transmit and/or receive content. In this case, the electronic device 100-1 may transmit content to the other electronic devices 100-2, 100-3, 100-4 via the server 200, or directly, i.e., without using the server 200.

In the case of sharing content using a temporary key, the scope of sharing content may be more limited compared to the case where general IDs and passwords are used, or where content is used directly from the electronic device 100-1. For instance, in a case where a general ID and password are used, or when content is used directly from electronic device 100-1, all of the content stored in a hard disk may be available. However, in a case of sharing content using a temporary key, only content which are stored in certain places on a hard disk may be available.

As described above, content may be shared more conveniently by forming a cloud network using a temporary key, and the security problem of leakage of user information in a user account may be addressed.

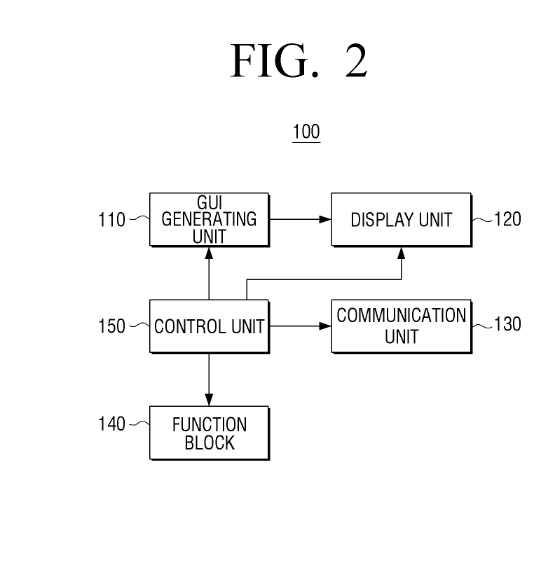

With reference to FIGS. 2 to 7, the electronic device 100 is explained in greater detail as follows. FIG. 2 is a block diagram of the electronic device 100 according to an exemplary embodiment. As illustrated in FIG. 2, the electronic device 100 comprises a GUI generating unit 110, a display unit 120, a communication unit 130, a function block 140 and a control unit 150.

The GUI generating unit 110 generates various GUIs for providing information or setting up an environment of an electronic device, and transmits it to the display unit 120.

Specifically, in a case where the electronic device 100 works as the electronic device 100-1 registering a temporary key, the GUI generating unit 110 may generate a GUI for setting a temporary key. Further, the GUI generating unit 100-1 may generate a GUI containing information that the other electronic devices 100-2, 100-3, 100-4 are authenticated by a server and access a cloud network. Also, the GUI generating unit 110 may generate a list of the other electronic devices 100-2, 100-3, 100-4 which are included in the cloud network, and a GUI for releasing the temporary key.

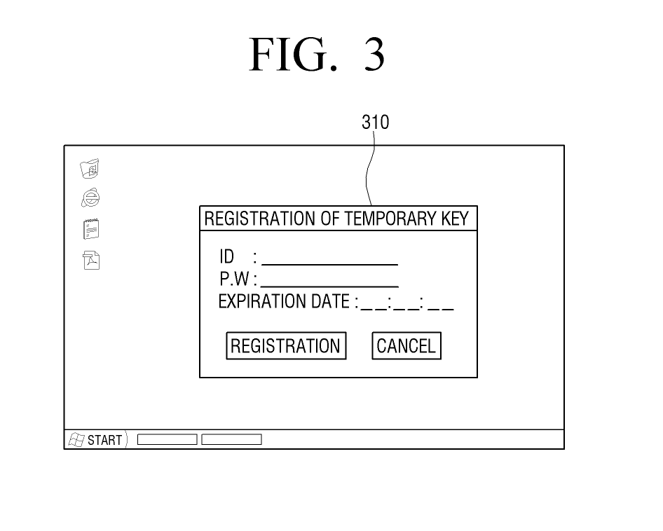

On the other hand, in a case where the electronic device 100 works as one of the other electronic devices 100-2, 100-3, 100-4, the GUI generating unit 110 may generate a GUI for authentication by the server and accessing the cloud network. Various GUIs described above will be explained in greater detail with reference to FIGS. 3 to 7.

The display unit 120 outputs images which are input from various sources and processed. In this case, the display unit 120 may display the GUI generated by the GUI generating unit 110 together.

The communication unit 130 performs a communication with the external server 200 or other electronic devices. In this case, the communication unit 130 could be embodied as communication modules such as a local area network (LAN) card, a modem, a Wi-Fi mode, a Bluetooth mode, etc.

The function block 140 performs the general functions of an electronic device, such as described in the following examples.

1) In a case where an electronic device is a computer or a notebook, the function block 140 operates various kinds of programs and applications.

2) In a case where an electronic device is a television, the function block 140 receives broadcasting content from an outside source and plays it.

3) In a case where an electronic device is a smart phone (mobile phone), the function block 140 performs a communication function communicating with an external device.

4) In a case where an electronic device is a Blue-ray Disk Player (BDP), the function block 140 plays content (especially, video content).

5) In a case where an electronic device is a game machine, the function block 140 saves and plays content (especially, game content).

6) In a case where an electronic device is a HTS (Home Theater System), the function block 140 plays and outputs content (especially, audio content).

The controlling unit 140 controls overall functions of the electronic device 100 by user's inputting. Specifically, the control unit 150 registers a temporary key with the external server 200, forms a cloud network with the other electronic devices 100-2, 100-3, 100-4 and shares content.

Specifically, the control unit 150 controls a GUI generating unit 110 to generate a temporary key registration GUI 310 in order to register a temporary key as illustrated in FIG. 3. In this case, the temporary key registration GUI 310 may be generated either if a user accesses server 200 and a predetermined menu in the server 200 is selected or if a predetermined button outside of the electronic device 100-1 is pressed. But this is only an exemplary embodiment, and the temporary key registration GUI 310 may be generated by other inputs by a user.

As illustrated in FIG. 3, the temporary key registration GUI 310 contains an item for setting the ID, password and expiration date of a temporary key. But this is only exemplary embodiments. The temporary key registration GUI 310 may contain items for setting only one or two items out of the ID, password and expiration date of temporary key, and may contain other setting information for setting a temporary key (for example, a user name).

If a temporary key is set via the temporary key registration GUI 310, the control unit 150 controls the communication unit 130 to transmit the information of the temporary key which is set via the temporary key registration GUI 310 and the information of the electronic device 100-1 to the server 200. In this case, the information of the electronic device 100-1 may include the network address, the type and the product name of electronic device 100-1 and etc.

As described above, if the information of a temporary key and the information of the electronic device 100-1 is transmitted from the electronic device 100-1 to the server 200, the server 200 authenticates the other electronic devices 100-2, 100-3, 100-4 using the information of the temporary key transmitted from the electronic device 100-1, and transmits the information of the electronic device 100-1 to the other electronic devices 100-2, 100-3, 100-4.

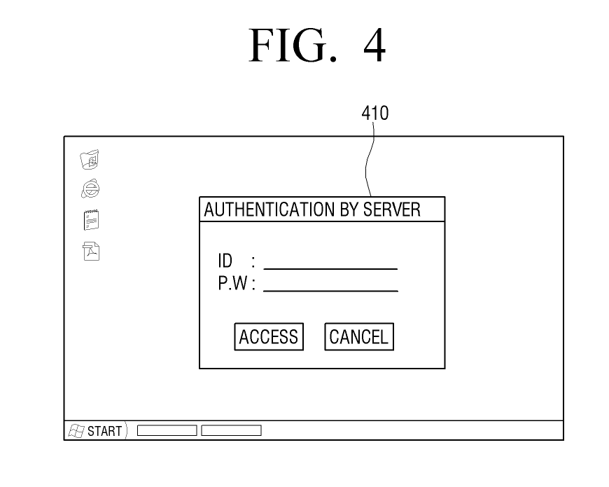

In the case that the electronic device 100 works like the other electronic device 100-2 to be authenticated by the server 200, the control unit 150 generates a server authentication GUI 410 for authentication by a server. Specifically, as illustrated in FIG. 4, the control unit 150 generates the server authentication GUI 410 for authentication, using the ID or password of the temporary key which is registered with the server 200. But this is only an exemplary embodiment, and in a case where only one of ID and password is set via the temporary key registration GUI 310, it may be allowed to input either one of corresponding ID or password to the server authentication GUI 410.

If the information of a temporary key is input to the server authentication GUI 410, the control unit 150 transmits the information of the temporary key which is input to the server authentication GUI 410 to the server 200. If the information of temporary key, which is input to the server authentication GUI 410, and the information of the temporary key, which is registered with the server 200, match each other, the control unit 150 is authenticated by the server 200 and may control the communication unit 130 to receive the information of the electronic device 100-1 which registered the temporary key with the server 200. And the control unit 150 may control the communication unit 130 to transmit the information of the other electronic device 100-2 to server 200.

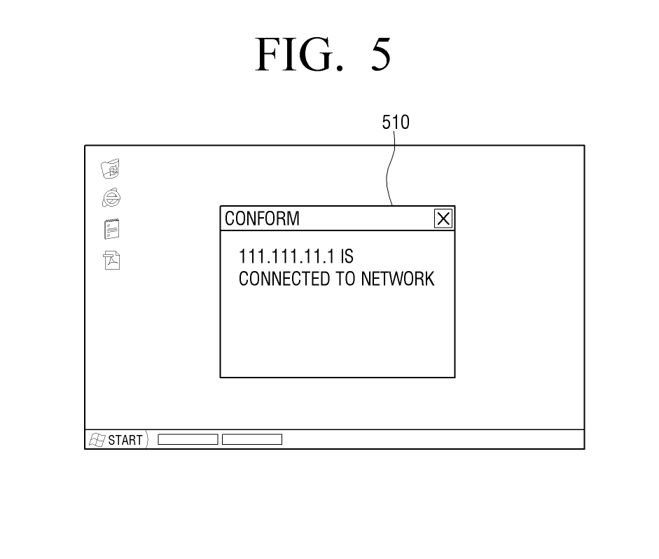

As explained in FIG. 4, if the other electronic device 100-2 is authenticated by the server 200, the control unit 150 of the electronic device 100-1 controls the communication unit 130 to receive the information of the other electronic device 100-2 and generates a GUI 510 containing the information that the other electronic device 100-2 which is authenticated by the server 200 is accessed to a cloud network. In this case, the GUI 510 containing the information that the other electronic device 100-2 is accessed to network may contain information such as the IP address or ID of the other electronic device 100-2 as illustrated in FIG. 5.

In addition, if a certain command is input by a user, the control unit 150 may control the GUI generating unit 110 to generate a access list 610 containing the information of the other electronic device 100-2 which is connected to a cloud network.

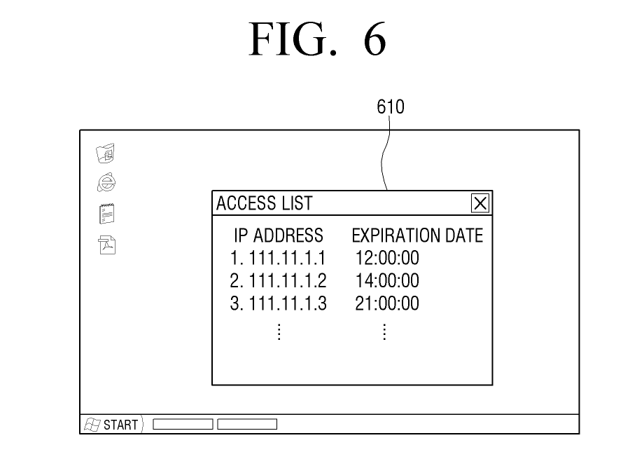

In this case, the access list 610 may include the information of IP address of other electronic device 100-2, the expiration date of a temporary key and etc as illustrated in FIG. 6. But this is only an exemplary embodiment, and the access list 610 may contain other information of the other electronic device 100-2.

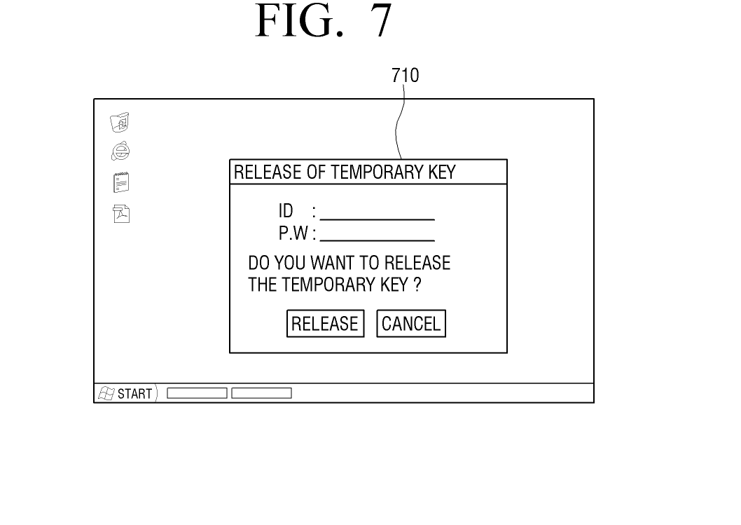

Also, the control unit 150 may release a temporary key by a user's command. Specifically, if the server 200 is accessed and a certain menu is selected, or a certain button outside of the electronic device 100-1 is pressed, the control unit 150 may generate a temporary key releasing GUI 710 as illustrated in FIG. 7.

In this case, the generated temporary key releasing GUI 710 may contain an item for inputting an ID and a password for releasing the temporary key which is set in FIG. 3. But this is only an exemplary embodiment, and the temporary key releasing GUI 710 may contain items for other purposes such as initialization.

If an ID and a password are input to the temporary key releasing GUI 710, the control unit 150 transmits the inputted temporary key to the server 200. And if the information of the temporary key which is input to the key releasing GUI 710 and the information of the registered temporary key match each other, the server 200 releases the network with other electronic device 100-2 using the registered temporary key.

However, releasing all of the network connections with other electronic devices 100-2 using the registered temporary key by releasing the registered temporary key is only one exemplary embodiment, and it is possible to release the network access of any number of the electronic devices 100-2 from among the plurality of other electronic devices 100-2.

In addition, in a case where the expiration date of the temporary key which is set via temporary key registration GUI 310, such as illustrated in FIG. 3, has passed, the control unit 150 transmits such information to the server 200. If the information that expiration date has passed is transmitted to the server 200, the server 200 releases the network of the other electronic devices 100-2 which have expired.

As described above, the electronic device 100 forms a network using a temporary key and thus, a user may share content more conveniently and the security problem of leakage of user information in a user account may be solved.

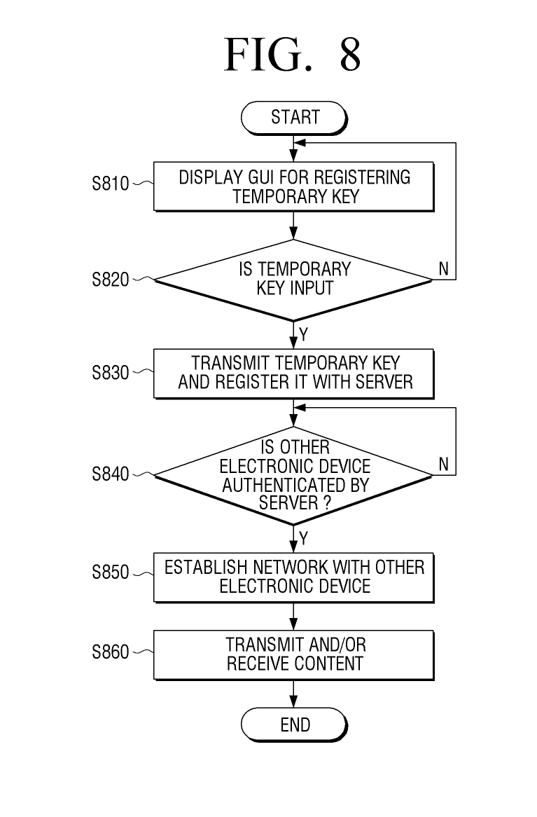

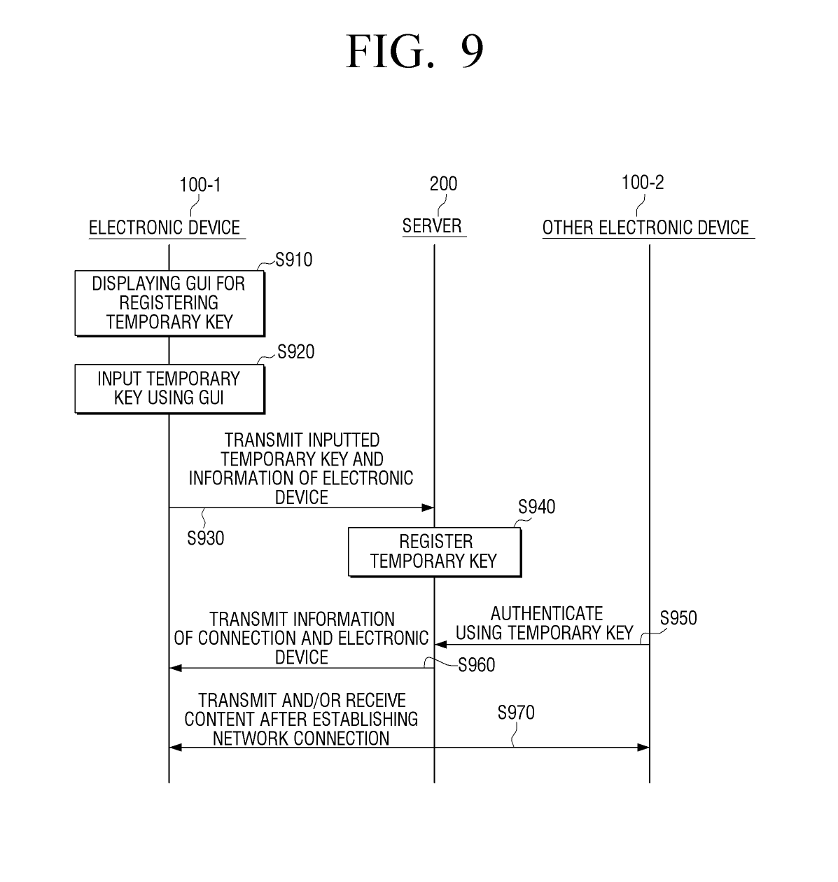

With reference to FIG. 8 and FIG. 9, the method for sharing content will be explained in greater detail as below.

FIG. 8 is a flowchart provided to explain a method for sharing content of the electronic device 100-1 according to an exemplary embodiment.

If a certain command is input by a user, the electronic device 100-1 displays a GUI for registering a temporary key (S810). In this case, if a user access the server 200, and if a certain menu in the server 200 is selected or a certain button outside of the electronic device 100-1 is pressed, the temporary key registration GUI 310 may be generated. The temporary key registration GUI 310 may contain an item for setting ID, password and expiration date of a temporary key as illustrated in FIG. 3.

If a temporary key is input by a user (S820-Y), the electronic device 100-1 transmits and registers the information of the temporary key to and with the server 200 (S830). Specifically, the electronic device 100-1 transmits the information of the temporary key which is set via the temporary key registration GUI 310 along with the information of the electronic device 100-1 to server 200.

If the temporary key is registered with the server 200, the electronic device 100-1 determines whether the other electronic device 100-2 is authenticated by the server 200 (S840). Specifically, if the information of the temporary key which is registered through operations S820 and S830 in the other electronic device 100-2 is input, the server 200 confirms the authentication of the other electronic device 100-2 and transmits the access information of the electronic device 100-1 and the information of the other electronic device 100-2. If the access information of the electronic device 100-1 and the information of the other electronic device 100-2 is transmitted, the electronic device 100-1 determines that the other electronic device 100-2 is authenticated by the server 200.

If the other electronic device 100-2 is authenticated by the server 200, the electronic device 100-1 forms a network with the other electronic device 100-2 (S850). If a network connection is established, the electronic device 100-1 transmits and/or receives content to and from the other electronic device 100-2 (S 860).

As described above, the electronic device 100-1 forms a cloud network by registering temporary key with the server and thus, a user may share content more conveniently with the other electronic device, and the security problem of leakage of user information in a user account may be solved by using temporary key.

FIG. 9 is a flowchart provided to explain a method for sharing content of the content sharing system 10 according to an exemplary embodiment.

If a certain command is input by a user, the electronic device 100-1 displays a GUI for registering a temporary key (S910). A temporary key is input via the temporary key registration GUI 310 according to a user input (S920).

If a temporary key is input, the electronic device 100-1 transmits the information of the inputted temporary key and the information of the electronic device 100-1 to the external server 200 (S930). If the information of temporary key and the information of the electronic device 100-1 is transmitted to the external server 200, the server 200 registers the key inputted with the temporary key registration GUI 310 as an One-Time Password (S940).

After the temporary key is registered, the other electronic device 100-2 is authenticated by the server using the temporary key (S950). Specifically, if the temporary key is input to the server access GUI 410 of the other electronic device 100-2 as illustrated in FIG. 4, the other electronic device 100-2 transmits the information of the temporary key to the server 200. If the information of the temporary key which is input to the server access GUI 410 is transmitted to the server 200, the server 200 determines whether the information of the temporary key transmitted from the other electronic device 100-2 and the registered information of the key match each other. If the information of the temporary key transmitted from the other electronic device 100-2 and the registered information of the temporary key match each other, the server 200 authenticates the other electronic device 100-1 as the electronic device 100 which will access a network.

If the other electronic device 100-2 is authenticated by the server 200, the server 200 transmits the access information of the other electronic device 100-2 and the information of the other electronic device 100-2 to electronic device 100-1 (S960). In this case, the information of other electronic device 100-2 may include information such as the network address and ID of the other electronic device 100-2.

If the access information of the other electronic device 100-2 is transmitted to the electronic device 100-1, the electronic device 100-1 forms a network with the other electronic device 100-2 and transmits and/or receives content (S970).

By the content sharing system 10 described above, a user may use content stored in electronic devices at home using an electronic device outside of the home and the security problem may be solved by using a temporary key.

Further, another exemplary embodiment may include a computer-readable recording medium including a program for running the dual view display method as described above. The computer-readable recording medium may include various types of recording apparatuses in which data being readable by a computer system is stored. Examples of the computer-readable recording medium may include a ROM, a RAM, a CD-ROM, a magnetic tape, a floppy disk, an optical data storing apparatus, etc. Further, computer-readable recording media may be distributed in computer systems connected through a network, so that they can store and execute codes readable by the computer in a distributed method.

The foregoing embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for sharing content of an electric device, the method comprising:
displaying a graphical user interface (GUI) for registering a temporary key;
if a temporary key is input via the GUI, transmitting the input temporary key to a server;
registering the input temporary key with the server;
establishing a network connection with the server and at least one other electronic device, if the at least one other electronic device is authenticated by the server via the registered temporary key; and
performing one of transmitting the content to the at least one other electronic device and receiving the content from the at least one other electronic device.

2. The method as claimed in claim 1, wherein the GUI comprises an item for setting at least one of an identification of the temporary key, a password of the temporary key and an expiration date of the temporary key.

3. The method as claimed in claim 1, wherein the transmitting the input temporary key comprises transmitting information of the electronic device along with the temporary key to the server and to register the information of the electronic device and the temporary key with the server.

4. The method as claimed in claim 1, wherein the establishing the network connection comprises:
generating another GUI including information that the network connection is established with the at least one other electronic device.

5. The method as claimed in claim 1, further comprising:
displaying a list including the at least one other electronic device.

6. The method as claimed in claim 1, further comprising:
if a command is input by a user, generating another GUI for releasing the temporary key; and
releasing the temporary key.

7. The method as claimed in claim 6, wherein the releasing the temporary key comprises inputting the registered temporary key to the other GUI.

8. The method as claimed in claim 1, wherein the performing the one of the transmitting the content to the at least one other electronic device and the receiving the content from the at least one other electronic device comprises performing the one of the transmitting the content to the at least one other electronic device and receiving the content from the at least one other electronic device either via the server or directly.

9. The method as claimed in claim 1, wherein the temporary key includes at least one of a disposable identification and a disposable password.

10. The method as claimed in claim 1, wherein the displaying comprises displaying the GUI if a button is pressed by a user.

11. An electronic device which communicates with a server and at least one other electronic device via a network connection, the electronic device comprising:
a graphical user interface (GUI) generating unit that generates a GUI for inputting a temporary key;
a display unit to display the generated GUI;
a communication unit that transmits the temporary key input via the GUI to the server; and
a control unit that controls the communication unit to perform one of transmitting the content to the at least one other electronic device and receiving the content from the at least one other electronic device, if the network connection is established with the at least one other electronic device and the at least one other electronic device is authenticated by the server via the temporary key.

12. The device as claimed in claim 11, wherein the GUI comprises an item for setting at least one of an identification of the temporary key, a password of the temporary key and an expiration date of the temporary key.

13. The device as claimed in claim 12, wherein the control unit controls the communication unit to transmit information of the electronic device and the temporary key to the server.

14. The device as claimed in claim 11, wherein the control unit controls the GUI generating unit to generate another GUI including information that the network connection is established with the at least one other electronic device, when the network connection is established.

15. The device as claimed in claim 11, wherein the control unit controls the GUI generating unit to generate a list including the at least one other electronic device and controls the display unit to display the generated list.

16. The device as claimed in claim 11, wherein the control unit controls the GUI generating unit to generate another GUI for releasing the temporary key, if a command is input by a user.

17. The device as claimed in claim 16, wherein the control unit releases the temporary key if the registered temporary key is input to the other GUI.

18. The device as claimed in claim 11, wherein the communication unit performs one of transmitting the content to the at least one other electronic device and receiving the content from the at least one other electronic device either via the server or directly.

19. The device as claimed in claim 11, wherein the temporary key includes at least one of a disposable identification and a disposable password.

20. The device as claimed in claim 11, wherein the control unit is further configured to control the GUI generating unit to generate the GUI if a button is pressed by a user.

21. An electronic device which communicates with at least one other electronic device via a network connection, the electronic device comprising:
a graphical user interface (GUI) generating unit configured to generate a GUI for inputting a temporary key;
a display unit configured to display the generated GUI;
a communication unit configured to communicate with at least one of a sever and the at least one other electronic device; and
a control unit configured to control the communication unit to transmit the temporary key to the server if the temporary key is input via the GUI, and to control the communication unit to receive information from the server,
wherein the control unit is further configured to control the communication unit to establish the network connection with the at least one other electronic device and to transmit the content to the at least one other electronic device via the network connection if the information received from the server includes authentication information indicating the at least one other electronic device is authenticated by the server via the temporary key.

22. The device as claimed in claim 21, wherein the temporary key comprises a one-time password.

23. The device as claimed in claim 21, wherein the GUI generating unit is further configured to generate another GUI for releasing the temporary key.

24. The device as claimed in claim 21, wherein the GUI generating unit is further configured to generate a GUI item for setting at least one of an identification of the temporary key, a password of the temporary key and an expiration date of the temporary key.

25. An electronic device which communicates with at least one other electronic device via a network connection, the electronic device comprising:
a graphical user interface (GUI) generating unit configured to generate a GUI for inputting a temporary key;
a display unit configured to display the generated GUI;
a communication unit configured to communicate with at least one of a sever and the at least one other electronic device; and
a control unit configured to control the communication unit to transmit the temporary key to the server in response to the temporary key being input via the GUI, and configured to determine whether the at least one other electronic device is authenticated by the server via the temporary key,
wherein the control unit is further configured to control the communication unit to establish the network connection with the at least one other electronic device and to transmit the content to the at least one other electronic device via the network connection if the at least one other electronic device is authenticated by the server via the temporary key.

26. An electronic device which communicates with at least one other electronic device via a network connection, the electronic device comprising:
a graphical user interface (GUI) generating unit configured to generate a GUI for inputting a temporary key;
a display unit configured to display the generated GUI;
a communication unit configured to communicate with at least one of a sever and the at least one other electronic device; and
a control unit configured to control the communication unit to transmit the temporary key to the server if the temporary key is input via the GUI, and to control the communication unit to receive information from the server,
wherein the control unit is further configured to control the communication unit to establish the network connection with the at least one other electronic device and to receive the content from the at least one other electronic device via the network connection if the information received from the server includes authentication information indicating the at least one other electronic device is authenticated by the server via the temporary key.
